(19) United States
(12) Patent Application Publication
(10) Pub. No.: US 2019/0329672 A1
(43) Pub. Date: Oct. 31, 2019

(54) METHODS AND APPARATUS TO FACILITATE ANTHROPOMETRIC SEAT ADJUSTMENTS

(71) Applicant: Ford Global Technologies, LLC, Dearborn, MI (US)

(72) Inventors: Patrick Brown, Sewickley, PA (US); Thomas Lee Miller, Ann Arbor, MI (US); Justin Bauer, Plymouth, MI (US); Michael Kipley, Saline, MI (US); Walter L. Stephens, JR., Farmington Hills, MI (US); Patrick Maloney, Livonia, MI (US)

(21) Appl. No.: 15/962,677

(22) Filed: Apr. 25, 2018

(51) Int. Cl. B60N 2/02; B60R 16/037; B60N 2/66; B60W 40/08

(52) U.S. Cl. CPC B60N 2/0252; B60R 16/037; B60N 2/0232; B60N 2/665; B60W 2540/00; B60N 2002/0268; B60W 2040/0881; B60W 2422/00; B60W 40/08

(57) ABSTRACT

Methods and apparatus to facilitate anthropometric seat adjustments are disclosed. An example vehicle comprises corresponding sensors and motors, a processor, and memory. The sensors generate actual position information of the motors. The processor and memory are configured to: convert the actual position information into first body dimensions; receive second body dimensions; convert the second body dimensions into target position information; and adjust the motors using the target position information.

### TECHNICAL FIELD

The present disclosure generally relates to vehicle components and, more specifically, methods and apparatus to facilitate anthropometric seat adjustments.

### BACKGROUND

In recent years, vehicles have been equipped with power-adjustable seats. Power-adjustable seats make vehicles more enjoyable to drive and/or improve vehicle comfort. Power-adjustable seats are often engaged by a driver via buttons of a vehicle.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

An example vehicle is disclosed. The vehicle comprises corresponding sensors and motors, a processor, and memory. The sensors generate actual position information of the motors. The processor and memory are configured to: convert the actual position information into first body dimensions; receive second body dimensions; convert the second body dimensions into target position information; and adjust the motors using the target position information.

An example method is disclosed. The method comprises: generating, with sensors, initial actual position information of corresponding motors; converting, with a processor, the initial actual position information into first body dimensions; converting, with the processor, received second body dimensions into target position information; and adjusting, with the processor, the motors using the target position information.

An example system is disclosed. The system comprises a mobile device, a first vehicle, and a second vehicle. The a first vehicle comprises: a first plurality of sensors, a corresponding first plurality of motors, a first processor, and a first memory. The first plurality of sensors generate actual position information of the first plurality of motors. The first processor and the first memory are configured to: convert the actual position information into body dimensions and transmit the body dimensions to the mobile device. The second vehicle comprises: a second plurality of motors, a second processor and a second memory. The second processor and the second memory are configured to: receive the body dimensions from the mobile device, convert the body dimensions into target position information, and adjust the second plurality of motors based on the target position information.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is a schematic view of first and second vehicles operating in accordance with the teachings of this disclosure in an environment.

FIG. 2 is a schematic view of the first vehicle of FIG. 1.

FIG. 3A is a schematic view of an example actuator assembly of FIG. 2.

FIG. 3B is a schematic view of another example actuator assembly of FIG. 2.

FIG. 4 is a block diagram of the electronic components of the vehicle of FIG. 1.

FIG. 5 is a more detailed block diagram of the domain converter of FIG. 4.

FIG. 6 illustrates a first actuator position information table converted into a body dimensions table and the body dimension table converted into a second actuator position information table.

FIG. 7 is a flowchart of a method to generate and send a body dimensions table, which may be implemented by the electronic components of FIG. 5.

FIG. 8 is a flowchart of a method to adjust a seat using a body dimensions table, which may be implemented by the electronic components of FIG. 5.

### DETAILED DESCRIPTION OF EXAMPLE EMBODIMENTS

While the invention may be embodied in various forms, some exemplary and non-limiting embodiments are shown in the drawings and will hereinafter be described with the understanding that the present disclosure is to be considered an exemplification of the invention and is not intended to limit the invention to the specific embodiments illustrated.

Traditionally, vehicles include processing and memory systems able to keep track of seat positions, mirror angles, steering wheel tilt, and other attributes. Drivers adjust these memory settings upon purchase of a new vehicle. In some instances, the driver may make multiple adjustments before finding a comfortable position and saving the position in the memory system. However, when a driver moves between vehicles (e.g., rental vehicles, leased vehicles, a new vehicle, etc.) he or she faces the challenge of adjusting seat positions all over again. Additionally, while innovations such as 30-way adjustable seats may yield improved driver comfort, the complexity of the process for the driver to find his or her ideal position whenever stepping into a new vehicle is increased and may be time consuming.

Even though a driver may move between differing types of vehicles (e.g., from a compact to a full-size pickup truck) with differing seat types (e.g., from a 30-way adjustable seat to a six-way adjustable seat) the body of the driver remains relatively constant. For example, the driver's body dimensions will not suddenly shift between when the driver drops off a SUV at a departure airport and when the driver picks up a rental hatchback at a destination airport. Anthropometrics—the study of human dimensions—provides a way to simplify drivers' transitions from one vehicle to another.

This disclosure provides methods and apparatus to facilitate anthropometric seat adjustments. Based on position information from a driver's seat, mirrors, steering wheel, pedal, etc., the vehicle's processing and memory system can estimate the driver's dimensions. The processing and memory system can transmit these dimensions to a driver's personal mobile device, a central facility, and/or a third party (e.g., dealership, rental company, etc.), linking them with a driver's individual body dimension profile. In some instances, when the driver enters a new vehicle, he or she may download these dimensions to the new vehicle from the mobile device. In some instances, the third party may download the driver's body dimensions to the new vehicle in anticipation of the driver's arrival at the third party to retrieve the new vehicle. The new vehicle's processing and memory system will convert (e.g., translate) these body dimensions into physical positions for the new vehicle and adjust the new vehicles driver's seat, mirrors, steering wheel, pedal, etc. to the physical positions. In other words, the driver's body dimensions act as a common language between the old and new vehicles' respective seating position languages. This translation should be relatively close to the driver's ideal positon. The driver may then make small adjustments to obtain the ideal position.

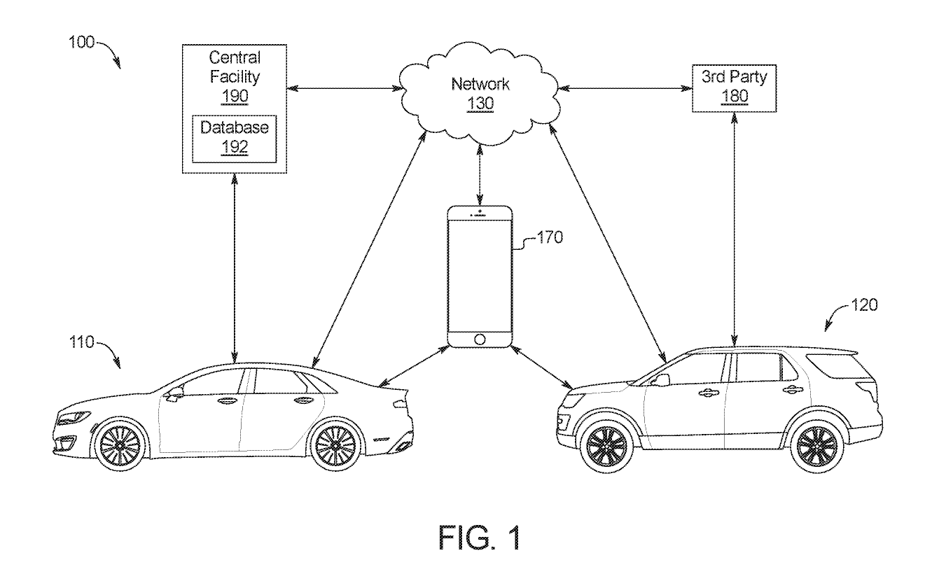

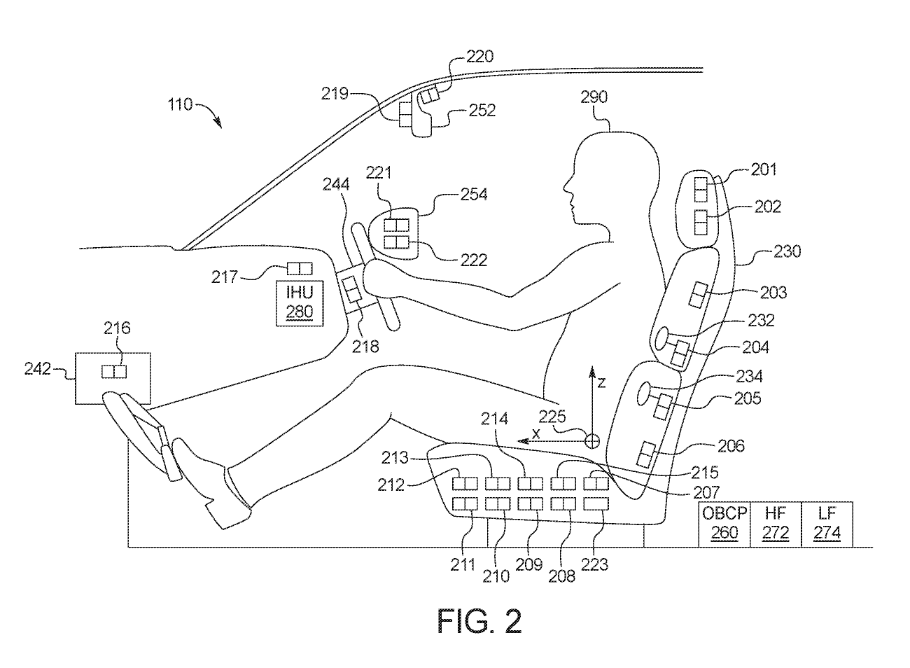

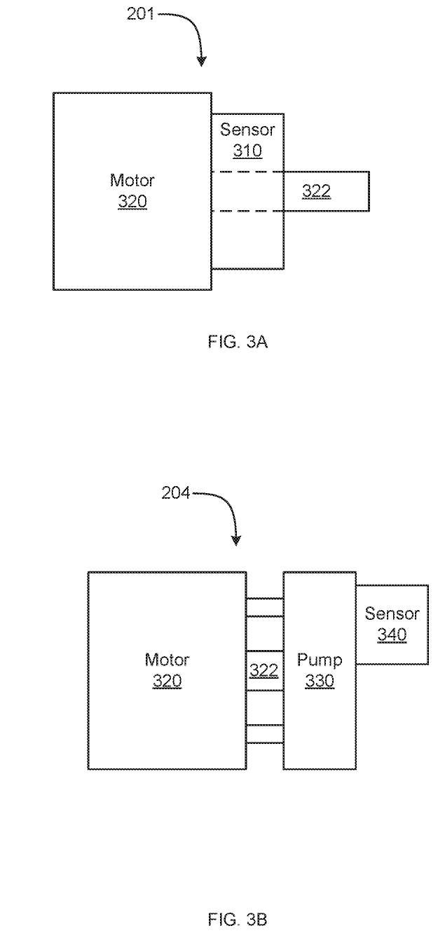

FIG. 1 is a schematic view of a first vehicle 110 and second vehicle 120 operating in accordance with the teachings of this disclosure in an environment 100. FIG. 2 is a schematic view of the first vehicle 110 of FIG. 1. FIG. 3A is a schematic view of an example actuator assembly 201 of FIG. 2. FIG. 3B is a schematic view of another example actuator assembly of FIG. 2.

Referring to FIG., 1, the environment 100 includes the first vehicle 110, the second vehicle 120, a network 130, a mobile device 170 of a driver, a third party facility 180, and a central facility 190. The first and second vehicles 110, 120, the mobile device 170, the central facility 190, and the third party facility 180 are in communication with one another via the network 130. The first and second vehicles 110, 120 are additionally in direct communication with the mobile device 170.

The first and second vehicles 110, 120 may be standard gasoline powered vehicles, hybrid vehicles, electric vehicles, fuel cell vehicles, and/or any other mobility implement type of vehicle. The first and second vehicles 110, 120 include parts related to mobility, such as a powertrain with an engine, a transmission, a suspension, a driveshaft, and/or wheels, etc. The first and second vehicles 110, 120 may be non-autonomous, semi-autonomous (e.g., some routine motive functions controlled by the vehicle 110), or autonomous (e.g., motive functions are controlled by the first and second vehicles 110, 120 without direct driver input).

The network 130 includes infrastructure-based modules (e.g., antenna(s), radio(s), etc.), processors, wiring, and software to broadcast messages and to establish connections between the first vehicle 110, the second vehicle 120, the central facility 190, the third party facility 180, and mobile device-based modules, (e.g., the mobile device 170). In some examples, the network 130 is a dealer network.

The mobile device 170 includes a processor, memory, software and wireless communication modules to broadcast messages and to establish connections with the first and second vehicles 110, 120 and with the network 130. The mobile device 170 may be, for example, a cellular telephone, a smartphone, a tablet, a laptop computer, a key fob, a universal serial bus (USB) device, etc.

The third party facility 180 is a location (e.g., a rental company, a racetrack, a dealership, etc.) where a driver may retrieve a vehicle that is not the driver's customary vehicle (e.g., the second vehicle 120). In some instances, processor(s) and memory at the third party facility 180 are in direct communication with the second vehicle 120 (e.g., via an on board diagnostics port).

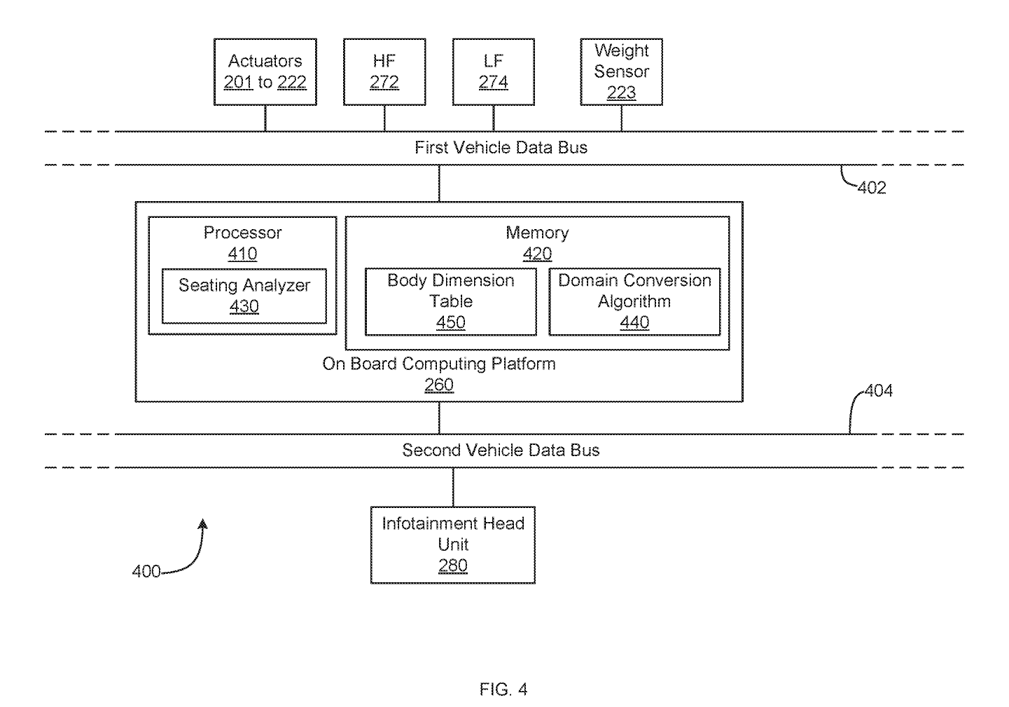

The central facility 190 includes a database 192 to store body dimensions of drivers, as will be explained in greater detail in conjunction with FIGS. 4-6.

As shown in FIG. 2, the first vehicle 110 includes a plurality of actuator assemblies 201 to 222, a weight sensor 223, a seating reference point (SgRP) 225, an adjustable seat 230, a pedal assembly 242, a steering assembly 244, a rear-view mirror 252, a side mirror 254, an on board computing platform (OBCP) 260 a high frequency (HF) transceiver 272, a low frequency (LF) transceiver 274, and an infotainment head unit (IHU) 280. In the example of FIG. 2, a driver 290 is seated in the seat 230.

As shown in FIG. 3A, the example actuator assembly 201 includes a sensor 310 engaged with a motor 320. The motor 320 is an electric motor with a rotating output shaft 322. In the example of FIG. 3A, the sensor 310 is disposed about the output shaft 322, as indicated by dashed hidden lines. In some examples, the sensor 310 measures a rotational position of the output shaft 322, including a number of revolutions. In some examples, the sensor 310 measures a linear position of a component engaged with the output shaft 322. It should be understood that the actuator assemblies 202, 203, and 206 to 222 are substantially identical to actuator assembly 201. Thus, each of the actuator assemblies 202, 203, and 206 to 222 includes a sensor engaged to a motor to measure (e.g., detect) rotational and/or linear positions of the motor.

As shown in FIG. 3B, the example actuator assembly 204 includes a sensor 340 engaged with an air pump 330, the motor 320, and the output shaft 322. In the example of FIG. 3B, the pump 330 is driven by the motor 320 via the shaft 322. The pump 330 is in fluid communication with an air bladder 232 disposed in the seat 230. In operation, the pump 330 inflates and deflates the air bladder 232. In some examples, the sensor 340 measures an output air pressure (e.g., in bar, psi, etc.) of the pump 330. It should be understood that the actuator assembly 205 substantially identical to actuator assembly 204 and thus includes a sensor engaged to a pump to measure an output pressure of the pump. The actuator assembly 205 is in fluid communication with the air bladder 234 disposed in the seat 230.

The sensors of actuator assemblies 201 to 222 and the weight sensor 223 may be arranged in and around the vehicle 110 in any suitable fashion. The sensors of actuator assemblies 201 to 222 and the weight sensor 223 generate sensor information. More specifically, the sensors of actuator assemblies 201 to 222 generate actual position information of their corresponding motors and the weight sensor 223 generates weight information of the driver 290.

In the illustrated example of FIG. 2, the SgRP 225 is a reference point specific to the first vehicle 110. The SgRP 225 is defined by the Society of Automotive Engineers (SAE) Standard J1517. The SgRP 225 serves as a reference frame origin point for the first vehicle 110. In the example of FIG. 2, the reference frame of the first vehicle 110 is expressed in terms of a fore-aft X axis perpendicular to an up-down Z axis. It should be understood that the reference frame may also be in terms of a side-to-side Y axis perpendicular to the X and Z axes (not shown). In some examples, positions of the adjustable seat 230, the pedal assembly 242, the steering assembly 244, the rear-view mirror 252, and the side mirror 254 in and/or relative to the first vehicle 110 are expressed as offset distance coordinates (e.g., (X, Z), (up/down, fore/aft), etc.) relative to the SgRP 225. It should be understood that the actual position information generated by the sensors of actuator assemblies 201 to 222 corresponds to the offset positions of the adjustable seat 230, the pedal assembly 242, the steering assembly 244, the rear-view mirror 252, and the side mirror 254 relative to the SgRP 225. In other words, rotational positions of the motors 320 and output pressures of the pumps 330 are related to offset distance coordinates from the SgRP 225 to each of the adjustable seat 230, the pedal assembly 242, the steering assembly 244, the rear-view mirror 252, and the side mirror 254.

In the illustrated example of FIG. 2, the seat 230 is a 30-way adjustable seat. The actuator assemblies 201 to 215 and the weight sensor 223 are included in the seat 230. The actuator assemblies 201 to 215 work to adjust the seat 230 to an ideal position for the driver by moving the seat 230 up and down, backward and forward, reclining and returning the seat back, extending and retracting the bottom cushion, tilting the bottom cushion, extending and retracting the head restraint, compressing and releasing bolsters, inflating and deflating lumbar supports, etc. The sensors of the actuator assemblies 201 to 215 report these adjustments to the OBCP 260. The weight sensor 223 measures a mass of the driver 290 and reports the mass to the OBCP 260.

The steering assembly 244 includes a steering wheel and a steering column. The steering assembly 244 is tiltable and extendable relative to the driver 290. In other words, the steering assembly 244 is adjustable up and down and in and out with respect to the driver 290 to accommodate the length of the driver's 290 arms and hands. The actuator assemblies 217, 218 are included in the steering assembly 244. The actuator assemblies 217, 218 work to adjust the steering assembly 244. The sensors of the actuator assemblies 217, 218 report these adjustments to the OBCP 260.

The pedal assembly 242 includes pedals to control power delivery to and/or rotational speed of the wheels of the first vehicle 110 (e.g., an accelerator pedal, a brake pedal, a clutch pedal, etc.). The pedal assembly 242 is extendable relative to the driver 290. In other words, the pedal assembly 242 is adjustable in and out with respect to the driver 290 to accommodate the length of the driver's 290 legs and feet. The actuator assembly 216 is included in the pedal assembly 242. The actuator assembly 216 works to adjust the pedal assembly 242. The sensor of the actuator assembly 216 reports these adjustments to the OBCP 260.

The rear-view mirror 252 and the side mirror 254 provide a view to the driver 290 of objects behind the driver 290. The mirrors 252, 254 are pivotable up and down and side to side (e.g., swivelable) to reflect aft objects to the driver 290. In other words, the mirrors 252, 254 are adjustable to give the driver 290 a clear line of sight to objects behind the driver 290. The actuator assemblies 219, 220 are included in the rear-view mirror 252. The actuator assemblies 221, 222 are included in the side mirror 254. The actuator assemblies 219 to 222 work to respectively adjust the mirrors 252, 254. The sensors of the actuator assemblies 219 to 222 report these adjustments to the OBCP 260. It should be understood that the first vehicle 110 includes a second side mirror opposite the first side mirror 254 and accompanying actuator assemblies (not shown).

The LF transceiver 274 includes the hardware and firmware to establish a connection with the mobile device 170. In some examples, the LF transceiver 274 implements the Bluetooth and/or Bluetooth Low Energy (BLE) protocols. The Bluetooth and BLE protocols are set forth in Volume 6 of the Bluetooth Specification 4.0 (and subsequent revisions) maintained by the Bluetooth Special Interest Group. In instances where the mobile device 170 is in range of the LF transceiver 274, the vehicle 110 is in communication with the mobile device 170 via the LF transceiver 274. In some examples, the first vehicle 110 receives body dimensions of the driver 290 via the mobile device 170.

The HF transceiver 272 includes antenna(s), radio(s) and software to broadcast messages and to establish connections between the first vehicle 110, infrastructure-based modules (e.g., a central facility, antennas, etc.), and mobile device-based modules, (e.g., the mobile device 170). In instances where the mobile device 170 is out of range of the LF transceiver 274, the first vehicle 110 is in communication with the mobile device 170 via the HF transceiver 272.

The OBCP 260 controls various subsystems of the first vehicle 110. In some examples, the OBCP 260 controls power windows, power locks, an immobilizer system, and/or power mirrors, etc. In some examples, the OBCP 260 includes circuits to, for example, drive relays (e.g., to control wiper fluid, etc.), drive brushed direct current (DC) motors (e.g., to control power seats, power locks, power windows, wipers, etc.), drive stepper motors, and/or drive LEDs, etc. In some examples, the OBCP 260 processes information from the sensors 310 to determine body dimensions of the driver 290. In some examples, the determined body dimensions are transmitted to the central facility 190 via the HF transceiver 272 for storage in the database 192. In some examples, the determined body dimensions are transmitted to the third party facility 180 via the HF transceiver 272. In some examples, the determined body dimensions are transmitted to the mobile device 170 via the HF transceiver 272 and/or the LF transceiver 274. In some examples, the OBCP 260 processes received body dimensions to adjust the seat 230, the pedal assembly 242, the steering assembly 244, and the mirrors 252, 254.

The IHU 280 provides an interface between the first vehicle 110 and a user. The IHU 280 includes digital and/or analog interfaces (e.g., input devices and output devices) to receive input from the user(s) and display information. The input devices may include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a heads-up display, a center console display (e.g., a liquid crystal display (“LCD”), an organic light emitting diode (“OLED”) display, a flat panel display, a solid state display, etc.), and/or speakers. In the illustrated example, the infotainment head unit 160 includes hardware (e.g., a processor or controller, memory, storage, etc.) and software (e.g., an operating system, etc.) for an infotainment system (such as SYNC® and MyFord Touch® by Ford®, Entune® by Toyota®, IntelliLink® by GMC®, etc.). Additionally, the IHU 280 displays the infotainment system on, for example, the center console display. In some examples, the first vehicle 110 receives seating position requests from the driver via the IHU 280.

It should be understood that the second vehicle 120 is similar to the first vehicle 110. The second vehicle 120 includes a SgRP, an adjustable seat, a plurality of actuator assemblies associated with the seat, an OBCP, a HF transceiver, and a LF transceiver. In some instances, the second vehicle 120 includes a weight sensor associated with the seat, a plurality of actuator assemblies associated with a pedal assembly, a steering assembly, a rear-view mirror, and a side mirror, and an IHU. The components of the second vehicle 120 operate in the same manner as the components of the first vehicle 110 described above.

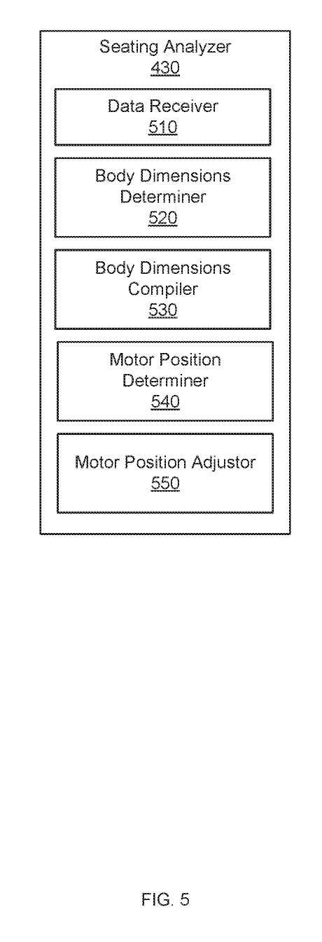

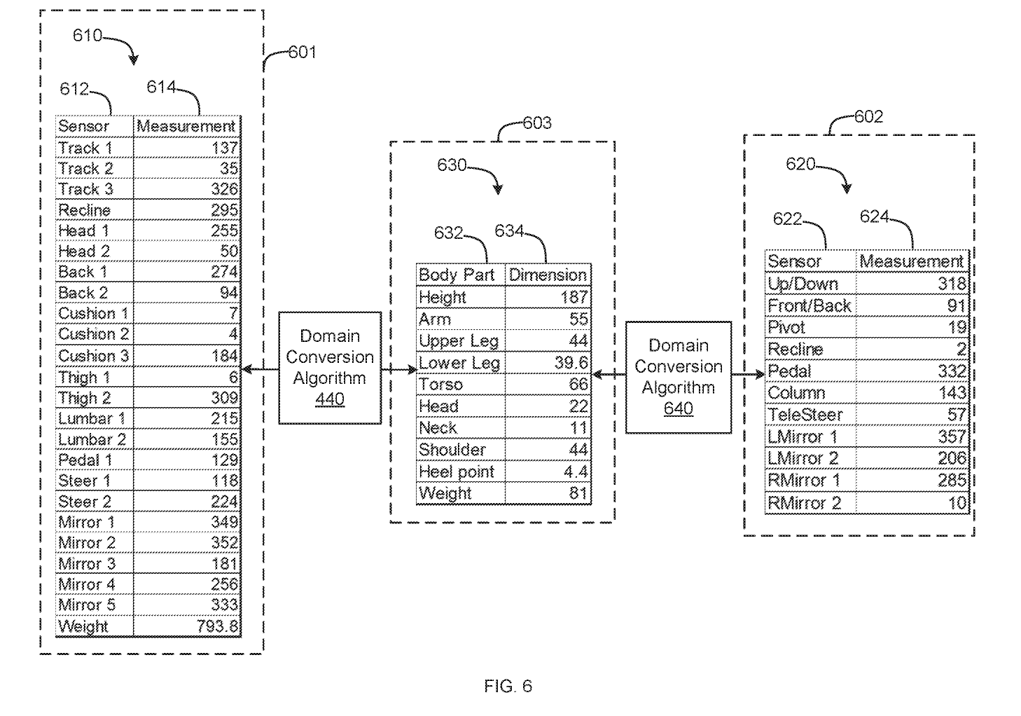

FIG. 4 is a block diagram of the electronic components of the first vehicle 110 of FIG. 1. FIG. 5 is a more detailed block diagram of a seating analyzer 430 of FIG. 4. FIG. 6 illustrates a first actuator position information table converted into a body dimensions table and the body dimension table converted into a second actuator position information table.

As shown in FIG. 4, the first vehicle data bus 402 communicatively couples the actuator assemblies 201 to 222, the HF transceiver 272, the LF transceiver 274, the weight sensor 223, the OBCP 260, and other devices connected to the first vehicle data bus 402. In some examples, the first vehicle data bus 402 is implemented in accordance with the controller area network (CAN) bus protocol as defined by International Standards Organization (ISO) 11898-1. Alternatively, in some examples, the first vehicle data bus 402 may be a Media Oriented Systems Transport (MOST) bus, or a CAN flexible data (CAN-FD) bus (ISO 11898-7). The second vehicle data bus 404 communicatively couples the OBCP 260 and the IHU 280. The second vehicle data bus 404 may be a MOST bus, a CAN-FD bus, or an Ethernet bus. In some examples, the OBCP 260 communicatively isolates the first vehicle data bus 402 and the second vehicle data bus 404 (e.g., via firewalls, message brokers, etc.). Alternatively, in some examples, the first vehicle data bus 402 and the second vehicle data bus 404 are the same data bus.

The OBCP 260 includes a processor or controller 410 and memory 420. In the illustrated example, the OBCP 260 is structured to include the seating analyzer 430. Alternatively, in some examples, the seating analyzer 430 may be incorporated into another electronic control unit (ECU) with its own processor 410 and memory 420. For example, the seating analyzer 430 may be stored in the database 192 and/or at the third party facility 180. In operation, the seating analyzer 430 generates individualized body dimensions tables 450 for drivers (e.g., the driver 290) based on sensor information from the sensors of the actuator assemblies 201 to 222 and the weight sensor 223. Further in operation, the seating analyzer 430 adjusts the seat 230, the steering assembly 244, the pedal assembly 242, and the mirrors 252, 254 via the motors of the actuator assemblies 201 to 222 based on a received body dimensions table. The processor or controller 410 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 420 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc.). In some examples, the memory 420 includes multiple kinds of memory, particularly volatile memory and non-volatile memory.

The memory 420 is computer readable medium on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 420, the computer readable medium, and/or within the processor 410 during execution of the instructions. The memory 420 stores the body dimensions table 450 and a domain conversion algorithm 440. It should be understood that the memory 420 may store multiple body dimensions tables for each driver who drives the first vehicle 110 in addition to the body dimensions table 450. Additionally or alternatively, the body dimensions table 450 and the domain conversion algorithm 440 may be stored in the database 192 and/or at the third party facility 180.

The domain conversion algorithm 440 is based on the internal and external geometries of the first vehicle 110; the geometries, travel limits, and relative placements of the seat 230, the pedal assembly 242, the steering assembly 244, and the mirrors 252, 254; the geometries, travel limits, and relative placements of the actuator assemblies 201 to 222; and weight information from the weight sensor 223. It should be understood that different models of vehicles with differing components and geometries will have differing domain conversion algorithms. In other words, different vehicle models have their own reference frames in which the vehicle's components are placed and operate. Thus, each model of vehicle may be referred to as having its own reference frame domain. Thus, measurements related to components of a specific vehicle model may be referred as being in the reference frame domain of that vehicle model. Further, the body dimensions table 450 may be referred to as being in an anthropometric domain.

The anthropometric domain serves as a common language between specific reference frame domains of vehicles. The conversion algorithms are used to translate between the specific reference frame domains of vehicles and the common anthropometric domain. As an analogy, where a Japanese speaker and a Swahili speaker do not speak one another's language but both speak English, the speakers may communicate effectively in English. Following this example, the Japanese and Swahili languages are analogous to the specific vehicle reference frame domains, the English language is analogous to the anthropometric domain, and the speakers' respective translation thought processes are analogous to the domain conversion algorithms. Continuing the example, just as the Japanese speaker's translation thought processes are different than the Swahili speaker's translation thought processes, the domain conversion algorithm of a first vehicle model is different than the domain conversion algorithm of a second vehicle model.

As shown in the example of FIG. 6, a first actuator position table 610 in a first reference frame domain 601 associated with the first vehicle 110 is translated into a second actuator position table 620 in a second reference frame domain 602 associated with the second vehicle 120 and vice versa via a body dimensions table 630 in the anthropometric domain 603. More specifically, the first actuator position table 610 is resolved into the body dimensions table 630 and vice versa via the first domain conversion algorithm 440 of the first vehicle 110. Further, the second actuator position table 620 is resolved into the body dimensions table 630 and vice versa via a second domain conversion algorithm 640 of the second vehicle 120. In other words, the first conversion algorithm 440 provides conversions between the first reference frame domain 601 and the anthropometric domain 603 that are calibrated for the first vehicle 110. Further, the second conversion algorithm 640 provides conversions between the second reference frame domain 602 and the anthropometric domain 603 that are calibrated for the second vehicle 120.

As shown in FIG. 6, the first actuator position table 610 has a first sensor label column 612 and a first measurement value column 614. In the example of FIG. 6, sensor labels listed in the first sensor label column correspond to the sensors of the actuator assemblies 201 to 222 and to the weight sensor 223. Further, the measurement values in the first measurement value column 614 are in units corresponding to the sensors of the actuator assemblies 201 to 222 and to the weight sensor 223 (e.g., degrees, radians, centimeters, newtons, etc.).

Similarly, the second actuator position table 620 has a second sensor label column 622 and a second measurement value column 624. In the example of FIG. 6, sensor labels listed in the second sensor label column 622 correspond to the sensors of the actuator assemblies and to the weight sensor of the second vehicle 120. Further, the measurement values in the second measurement value column 624 are in units corresponding to the sensors of the second vehicle 120. It should be appreciated that, in the example of FIG. 6, the second vehicle 120 has fewer seating adjustments than the first vehicle 110 and that the seating adjustments shown in the second actuator position table 620 are labeled differently than those of the first actuator position table 610.

Additionally, the body dimension table 630 has a body part label column 632 and a dimension value column 634. The dimension values in the dimension value column 634 are in units corresponding to the body parts of a driver (e.g., centimeters, kilograms, etc.). It should be appreciated that the anthropometric domain provides a way to convert between the first and second reference frame domains 601, 602 despite the first and second reference frame domains 601, 602 differences.

Referring to FIG. 4, in some examples, the domain conversion algorithm 440 is programmed into the OBCP 260 during production of the first vehicle 110. The domain conversion algorithm 440 may be periodically updated during service of the vehicle 110 to reflect changes with respect to the actuator assemblies 201 to 222 and the weight sensor 223 (e.g., replacement, recalibration, etc.).

The terms “non-transitory computer-readable medium” and “tangible computer-readable medium” should be understood to include a single medium or multiple media, such as a centralized or distributed database, and/or associated caches and servers that store one or more sets of instructions. The terms “non-transitory computer-readable medium” and “tangible computer-readable medium” also include any tangible medium that is capable of storing, encoding or carrying a set of instructions for execution by a processor or that cause a system to perform any one or more of the methods or operations disclosed herein. As used herein, the term “tangible computer readable medium” is expressly defined to include any type of computer readable storage device and/or storage disk and to exclude propagating signals.

As shown in FIG. 5, the seating analyzer 430 includes a data receiver 510, a body dimensions determiner 520, a body dimensions compiler 530, a motor position determiner 540, and a motor position adjustor 550.

In operation, in some instances the data receiver 510 receives sensor information from the sensors of the actuator assemblies 201 to 222 and the weight sensor 223. More specifically, in such instances, the data receiver 510 receives actual position information for each of the motors of the actuator assemblies 201 to 222 from the corresponding sensors and weight information from the weight sensor 223.

In operation, in some instances, the data receiver 510 receives body dimension tables. In some instances the data receiver receives the body dimensions tables from the mobile device 170 via the LF transceiver 274. In some instances, the data receiver 510 receives the body dimensions table from the central facility 190, the third party facility 180, and/or the mobile device 170 via the network 130 and the HF transceiver 272.

In operation the body dimensions determiner 520 converts sensor information into body dimensions measurements. More specifically, the body dimensions determiner 520 accesses the domain conversion algorithm 440 stored in the memory 420 and applies the domain conversion algorithm 440 to the sensor information generate the body dimensions measurements. In other words, the body dimensions determiner converts sensor information in the vehicle reference frame domain into the anthropometric domain using the domain conversion algorithm.

In operation the body dimensions compiler 530 compiles the body dimensions measurements into a body dimensions table (e.g., the body dimensions table 450). More specifically, the body dimensions compiler 530 receives the body dimensions measurements from the body dimensions determiner 520 and records the body dimensions measurements into the body dimensions table. In some instances, the body dimensions compiler 530 transmits the body dimensions table (e.g., the body dimensions table 630) to the mobile device 170 via the LF transceiver 274. Thus, a driver (e.g., the driver 290) may carry his or her own body dimensions table from one vehicle to another (e.g., from the first vehicle 110 to the second vehicle 120). In some instances, the body dimensions compiler 530 transmits the body dimensions table to the central facility 190, the third party facility 180, and/or the mobile device 170 via the network 130 and the HF transceiver 272. Thus, the third party facility 180 may access the body dimensions table to adjust the seating position of a new (e.g., newly purchased, leased, rented, etc.) vehicle in anticipation of a driver's arrival at the third party facility 180 (e.g., in the first vehicle 110) to retrieve the new vehicle (e.g., the second vehicle 120).

In operation the motor position determiner 540 converts body dimensions measurements into target position information. More specifically, the motor position determiner 540 accesses the domain conversion algorithm 440 stored in the memory 420 and applies the domain conversion algorithm 440 to the body dimensions measurements to generate target positions for each of the motors of the actuator assemblies 201 to 222. In other words, the body dimensions determiner converts body dimension information in the anthropometric domain into target position information in the vehicle reference frame domain using the domain conversion algorithm 440.

In operation the motor position adjustor 550 adjusts the motors of the actuator assemblies 201 to 222 to the target positions. More specifically, the motor position adjustor 550 receives the target position information from the motor position determiner 540 and sensor information from the data receiver 510. The motor position adjustor 550 energizes the motors of the actuator assemblies 201 to 222 until the sensor information corresponding to the motors matches the corresponding target positions. Thus, the seat 230, the pedal assembly 242, the steering assembly 244, and the mirrors 252, 254 may be adjusted to a driver's ideal seating position without input from the driver. It should be understood that matching of the actual position information to the target position information may be within a tolerance window (e.g., plus or minus 5 degrees, plus or minus 1 degree, etc.).

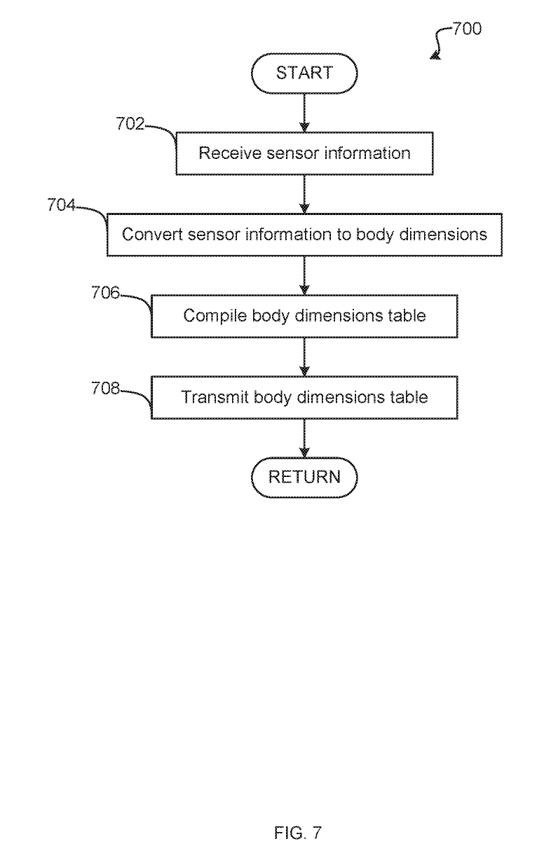

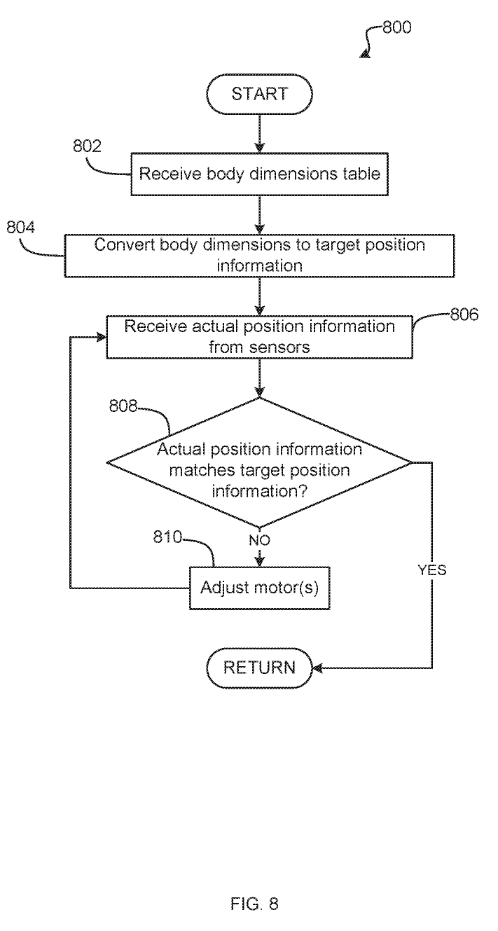

FIG. 7 is a flowchart of a method 700 to generate and send a body dimensions table, which may be implemented by the electronic components of FIG. 4. FIG. 8 is a flowchart of a method 800 to adjust a seat using a body dimensions table, which may be implemented by the electronic components of FIG. 4. The flowcharts of FIGS. 7 and 8 are representative of machine readable instructions stored in memory (such as the memory 420 of FIG. 4) that comprise one or more programs that, when executed by a processor (such as the processor 410 of FIG. 4), cause the vehicle 110 to implement the example seating analyzer 430 of FIGS. 4 and 5. Further, although the example program(s) is/are described with reference to the flowcharts illustrated in FIGS. 7 and 8, many other methods of implementing the example seating analyzer 430 may alternatively be used. For example, the order of execution of the blocks may be changed, and/or some of the blocks described may be changed, eliminated, or combined.

Referring to FIG. 7, initially, at block 702, data receiver 510 receives sensor information from the sensors of the actuator assemblies 201 to 222 and the weight sensor 223. As discussed above, the sensor information includes actual position information for each of the motors of the actuator assemblies 201 to 222 and weight information of the driver 290.

At block 704, the body dimensions determiner 520 converts the sensor information into body dimensions measurements. More specifically, the body dimensions determiner 520 accesses the domain conversion algorithm 440 in the memory 420 and applies the domain conversion algorithm 440 to the sensor information to yield the body dimensions measurements, as discussed above.

At block 706, the body dimensions compiler 530 compiles the body dimensions measurements into the body dimensions table 450. More specifically, the body dimensions compiler 530 receives the body dimensions measurements from the body dimensions determiner 520 and records the body dimensions measurements into the body dimensions table 450, as discussed above.

At block 708, the body dimensions compiler 530 transmits the body dimensions table 450 to one or more of the mobile device 170, the third party facility 180, and/or the central facility 190 via the HF transceiver 272 and the LF transceiver 274, as discussed above. Thus, the body dimensions table 450 may be carried to and/or accessed by another vehicle. The method 700 then returns to block 702.

Referring to FIG. 8, initially, at block 802, the data receiver 510 receives a body dimensions table from the mobile device 170, the central facility 190, and/or the third party facility 180 via the HF transceiver 272 and/or the LF transceiver 274. As discussed above, the body dimensions table include body dimensions measurements of a driver.

At block 804, the motor position determiner 540 converts the body dimensions measurements into target positions for the motors of the actuator assemblies 201 to 222. More specifically, the motor position determiner 540 accesses the domain conversion algorithm 440 in the memory 420 and applies the domain conversion algorithm 440 to the body dimensions measurements to yield the target position information, as discussed above.

At block 806, the motor position adjustor 550 receives sensor information from the sensors of the actuator assemblies 201 to 222. As discussed above, the sensor information includes actual position information for each of the motors of the actuator assemblies 201 to 222.

At block 808, the motor position adjustor 550 determines whether the actual position information matches the target position information.

If, at block 808, the actual position information does not match the target position information, the method proceeds to block 810.

At block 810, the motor position adjustor 550 energizes the motors of the actuator assemblies 201 to 222 to adjust the seat 230, the pedal assembly 242, the steering assembly 244, and the mirrors 252, 254. The method 800 then returns to block 806. Thus, between blocks 806, 808, and 810, the motor position adjustor 550 monitors and adjusts the positions of the motors of the actuator assemblies 201 to 222 based on updated actual position information from the sensors of the actuator assemblies 201 to 222.

If, at block 808, the actual position information matches the target position information, the method 700 then returns to block 702.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or.” The terms “includes,” “including,” and “include” are inclusive and have the same scope as “comprises,” “comprising,” and “comprise” respectively.

From the foregoing, it should be appreciated that the above disclosed apparatus and methods may provide anthropometric seat adjustments. By converting sensor information in various vehicle reference frame domains into body dimensions in a common anthropometric domain and transmitting the body dimensions to a networked storage location (e.g., a mobile device, a central facility, a third party facility, etc.), seating settings may be more easily transferred between vehicles. Thus, once a driver finds his or her ideal seating position, seating positions in subsequent vehicles driven by the driver may be adjusted without seat adjustment input from the driver. It should also be appreciated that the disclosed apparatus and methods provide a specific solution—converting sensor information in specific vehicle reference frame domains to body dimensions in a common anthropometric domain and saving the body dimensions to a networked device—to a specific problem—repeated adjustments to seating positions whenever a driver enters a new vehicle.

As used here, the terms “module” and “unit” refer to hardware with circuitry to provide communication, control and/or monitoring capabilities, often in conjunction with sensors. “Modules” and “units” may also include firmware that executes on the circuitry.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
sensors to generate actual position information of corresponding motors; and
a processor and memory configured to:
convert the actual position information into first body dimensions;
receive second body dimensions;
convert the second body dimensions into target position information; and
adjust the motors using the target position information.

2. The vehicle of claim 1, wherein the processor is configured to:
convert the actual position information into the first body dimensions using a domain conversion algorithm; and
convert the second body dimensions into the target position information using the domain conversion algorithm.

3. The vehicle of claim 2, further comprising:
an adjustable seat;
a pedal assembly;
a steering assembly; and
an adjustable side mirror;
wherein the domain conversion algorithm is based on:
internal and external geometries of the vehicle;
geometries of the adjustable seat, the pedal assembly, the steering assembly, and the adjustable side mirror;
travel limits of the adjustable seat and the adjustable side mirror; and
relative placements of the adjustable seat, the pedal assembly, the steering assembly, and the adjustable side mirror.

4. The vehicle of claim 1, further comprising a transceiver, wherein the processor is further configured to transmit the first body dimensions to at least one of a mobile device, a central facility, or a third party facility via the transceiver.

5. The vehicle of claim 1, wherein the motors are disposed in one or more of an adjustable seat, an adjustable steering assembly, an adjustable pedal assembly, an adjustable side mirror, and an adjustable rear view mirror.

6. The vehicle of claim 5, wherein adjustment of the motors adjusts a seating position of a driver.

7. The vehicle of claim 1, wherein:
the actual position information is initial actual position information; and
the processor is further configured to:
receive updated actual position information from the sensors; and
to adjust the motors, energize the motors until the updated actual position information matches the target position information.

8. The vehicle of claim 1, further comprising a transceiver, wherein the second body dimensions are received from at least one of a mobile device, a central facility, or a third party facility via the transceiver.

9. A method comprising:
generating, with sensors, initial actual position information of corresponding motors;
converting, with a processor, the initial actual position information into first body dimensions;
converting, with the processor, received second body dimensions into target position information; and
adjusting, with the processor, the motors using the target position information.

10. The method of claim 9, wherein:
converting the initial actual position information into the first body dimensions comprises:
accessing, with the processor, a domain conversion algorithm; and
applying with the processor, the domain conversion algorithm to the initial actual position information; and
converting the second body dimensions into the target position information comprises:
accessing, with the processor, the domain conversion algorithm; and
applying with the processor, the domain conversion algorithm to the second body dimensions.

11. The method of claim 10, wherein the domain conversion algorithm is based on:
internal and external geometries of a vehicle comprising an adjustable seat, a pedal assembly, a steering assembly, and an adjustable side mirror;
geometries of the adjustable seat, the pedal assembly, the steering assembly, and the adjustable side mirror;
travel limits of the adjustable seat and the adjustable side mirror; and
relative placements of the adjustable seat, the pedal assembly, the steering assembly, and the adjustable side mirror.

12. The method of claim 9, further comprising transmitting, with a transceiver, the first body dimensions to at least one of a mobile device, a central facility, or a third party facility.

13. The method of claim 9, wherein the motors are disposed in one or more of an adjustable seat, an adjustable steering assembly, an adjustable pedal assembly, an adjustable side mirror, and an adjustable rear view mirror.

14. The method of claim 9, further comprising generating, with the sensors, updated actual position information, wherein adjusting the motors using the target position information comprises energizing the motors until the updated actual position information matches the target position information.

15. The method of claim 9, further comprising receiving, with a transceiver, the second body dimensions from at least one of a mobile device, a central facility, or a third party facility.

16. A system comprising:
a mobile device;
a first vehicle comprising:
a first plurality of sensors to generate actual position information of a corresponding first plurality of motors; and
a first processor and a first memory configured to:
convert the actual position information into body dimensions; and
transmit the body dimensions to the mobile device; and
a second vehicle comprising:
a second plurality of motors; and
a second processor and a second memory configured to:
receive the body dimensions from the mobile device;
convert the body dimensions into target position information; and
adjust the second plurality of motors based on the target position information.

17. The system of claim 16, wherein:
the first processor is configured to convert the actual position information into the body dimensions using a first domain conversion algorithm; and
the second processor is configured to convert the body dimensions into the target position information using a second domain conversion algorithm.

18. The system of claim 17, wherein:
the first domain conversion algorithm is based on first external and first internal geometries of the first vehicle; and
the second domain conversion algorithm is based on second external and second internal geometries of the second vehicle.

19. The system of claim 16, further comprising a third party facility and wherein:
the first processor is further configured to transmit the body dimensions to the third party facility; and
the second processor is further configured to receive the body dimensions from the third party facility.

20. The system of claim 19, wherein:
the actual position information is first actual position information;
the second vehicle comprises a second plurality of sensors corresponding to the second plurality of motors to generate second actual position information of the corresponding second plurality of motors; and
to adjust second plurality of motors, the second processor is further configured to energize the second plurality of motors until the second actual position information matches the target position information.
